(19) United States
(12) Patent Application Publication
(10) Pub. No.: US 2018/0048105 A1
(43) Pub. Date: Feb. 15, 2018

(54) Device for Soldering Wires to an LED Lighting Strip

(71) Applicant: Connlaoth MulHolland, San Francisco, CA (US)

(72) Inventor: Connlaoth MulHolland, San Francisco, CA (US)

(21) Appl. No.: 15/673,378

(22) Filed: Aug. 9, 2017

Related U.S. Application Data
(60) Provisional application No. 62/373,055, filed on Aug. 10, 2016.

(51) Int. Cl. H01R 43/02; B23K 3/06; F21V 23/00

(52) U.S. Cl. CPC H01R 43/0235; F21V 23/001; H01R 43/0249; H01R 43/0263; B23K 3/0615; B23K 3/063; F21S 4/20

(57) ABSTRACT

The invention is a hand-held portable device for soldering electrical wires to an LED lighting strip. The device comprises mechanisms for positioning and securing LED strip contact pads, wires, and solder in position in proximity to a heating element. When the heating element is engaged, solder is melted and forms a bead which connects the wires to the LED strip contact pads. Various configurations of the device are described, as are methods of using such devices to connect LED strips to power sources.

### CROSS-REFERENCE TO RELATED APPLICATIONS

This application claims the benefit of priority to U.S. Provisional Application Ser. No. 62/373,055 entitled “LED Tape Soldering Tool,” filed Aug. 10, 2016, the contents of which are hereby incorporated by reference.

### BACKGROUND OF THE INVENTION

LED strip lighting comprises a flexible ribbon-like tape or strip having multiple LED elements. This versatile lighting option has become increasingly popular, and LED strip lights are available in a range of sizes, colors, and luminosities.

The strip typically comprises a ribbon of repeating linearly-disposed segments, each segment comprising one or more light emitting diodes and a pair of contact pads (electrically conductive leads) for connecting the strip to a power source. The LED strip can be cut to the desired length at “cut-points” marking the boundary between segments and can be connected to power by the contacts at the cut end.

Various devices exist for solderless connection of the strip to the wires of a power source. However, in many situations, it is desirable to solder the contact points to the power wires. Currently, in order to solder electrical wires to the LED strip contacts, an electrician must hold onto the strip, and must then hold each wire in place while operating a standard soldering device to solder the tip of each wire to one of the contact points on the strip. This process can be frustrating and time-consuming because the multiple elements must be precisely aligned and held in place, often without the benefit of a working surface. For example, the electrician is often standing on a ladder or working in a constrained space, making it difficult to hold and align the strip and the wires while employing a soldering device.

Accordingly, there is a need in the art for tools and methods that simplify the process of soldering an LED strip to wires.

### SUMMARY OF THE INVENTION

Provided herein is a novel tool which greatly simplifies the process of connecting an LED strip to a power source. The tool comprises a hand-held device which may be used to align wires and LED strip contacts together and which enables them to be readily soldered. The scope of the invention further encompasses methods of using such devices for soldering electrical wires to LED strips.

### BRIEF DESCRIPTION OF THE FIGURES

FIG. 1A is a perspective forward looking view of a first embodiment of the invention with the top solder holding portion in the closed position.

FIG. 1B a perspective rearward looking view of the first exemplary embodiment.

FIG. 2 is a section view that laterally bisects the device.

FIG. 3 is a perspective view of two standard tubes of solder positioned for loading into the solder holding compartment.

FIG. 4 is a perspective view of the invention with hinged device in the open position.

FIG. 5 is a lateral view of the first exemplary embodiment.

FIG. 6 is a perspective view of a second exemplary embodiment of the invention.

FIG. 7 is a perspective view of the second exemplary embodiment with the hinged top plate in the open position.

FIG. 8 is a perspective view of the second exemplary embodiment of the invention with the hinged top plate in the closed position.

FIG. 9 is a section view of the second embodiment.

FIG. 10 is a partial perspective view of the second exemplary embodiment of the invention showing the solder wire feed mechanism.

FIG. 11 is a partial perspective view of the second exemplary embodiment showing the solder, LED strip and wires in position over the heating elements for soldering.

### DETAILED DESCRIPTION OF THE INVENTION

In a first aspect, the scope of the invention encompasses a device to facilitate the soldering of LED strip to the wires of a power source. Specifically, the device enables an operator to solder each of the terminal contact pads of at the end of an LED strip to an electrical wire.

As used herein, “LED strip” or “strip” refers to LED strip lights, as known in the art. These strips comprise a series of LED's, which are typically connected to a driver or controller comprising a power source and control elements. Typical driver voltages are 12 V, 24 V, or in the case of USB-driven tapes, 5 V. The strip is available in various widths, for example 2 mm, 5 mm, or 8 mm. The strips are typically sold in long lengths (e.g. 10.5 meters). The strip comprises multiple segments, each segment comprising one or more LEDs and a pair of contact pads, each contact pad being in connection with a wire running the length of the strip. These contact pads can be connected to wires in order to power the LEDs present on the strip.

At the boundary between each segment, cut points indicate where the tape can be cut to form strips of different lengths, or the entire strip can be used as shipped. The end of an LED strip that is to be connected to wires will be referred to herein as the terminal end of the LED strip, and the contact pads present at this end will be referred to herein as the terminal contact pads.

The LED strip may comprise two or more contact pads at its end, depending on the type of LEDs used. Many LED strips use DC-powered LEDs and have two contact pads per segment (e.g., for connection to negative and positive wires). Other strips use AC-powered LEDs and may comprise three contact pads in each segment, for example, for connection to hot, neutral, and ground wires. Other types of LEDs may require four, five, six, or more connections. For convenience, the figures provided herein depict tools for use with two-wire LED strips. However, it will be understood that the scope of the invention encompasses devices and methods for the connection of any number of wires and contact pads.

The purpose of the tool of the invention is to provide a means for users to easily join the contact pads of an LED strip to wires. The device provides a platform that conveniently positions the wires and contact pads together and which has an integrated soldering system for applying a solder bead to connect each wire to its corresponding contact pad. The device greatly simplifies the task of connecting LED strip to a power source. The device is portable and can be operated by a single person.

In one aspect, the invention comprises a device, for connecting each terminal contact pad of an LED strip to an electrical wire, the device comprising:
one or more heating elements;
an LED strip holder comprising one or more anchoring elements that, when engaged or deployed, will secure the end of the LED strip such that each terminal contact pad thereof overlays, is in contact with, or is in proximity to one of the one or more heating elements;
a wire holder comprising one or more anchoring elements that, when engaged or deployed, will secure electrical wires or a cable comprising multiple electrical wires, such that the end of each such electrical wire is in contact with or is in proximity to one of the terminal contact pads of the LED strip;
a solder wire feed mechanism, wherein the solder wire feed mechanism is configured to (1) position one or more solder wires such that the end of each such solder wire is in contact with or is in proximity to one of the terminal contact pads of the LED strip, and (2) wherein the solder wire feed mechanism, when engaged, will advance the end of each of the one or more solder wires towards a terminal contact pad of the LED strip, for the formation of a solder bead;
a control element that enables an operator to activate and turn off the one or more heating elements; and
a heating element power source or power source connector.

The various elements of the invention are described next.

Body or Housing. The tool of the invention will comprise a body, which integrates the various elements of the device in a single assembly or housing. The body is preferably sized and configured such that it can be held with one hand, freeing the operator's other hand to position and operate the components.

Heating Elements. The body will comprise one or more heating elements. Each heating element may comprise a heating surface or pad, for example, a metal or ceramic pad. The heating surface may be flat or curved. In one implementation, a single heating element is used. For example in one embodiment, a heating element (for example, a rectangular heating element) being about the width of the LED strip is used. Alternatively, two or more side-by-side heating elements may be used.

The heating element(s) will be located in or on the body of the device and will form a convergence point for the LED strip and wires where they will be joined together. In one embodiment, the heating element is flat and the end of the LED strip sits thereon, such that the terminal contact pads overlay the heating element surface and are heated from below (through the intervening structure of the LED strip, which is generally heat resistant).

Typically, the heating elements will comprise electrical resistance heating elements. In one embodiment, the device comprises an integrated power source, for example, a rechargeable battery housed within a battery compartment of the device. In an alternative embodiment, the device comprises a connection for an external power source, the connection comprising a power cord or power cord jacks, with the external power source comprising an external battery pack or electrical outlet. In an alternative embodiment, the heating element is a combustion or catalytic heating element powered by a fuel source.

LED Strip Holder. One component of the device is an LED strip holder. The strip holder comprises one or more elements that can be engaged or deployed to secure the end of an LED strip in place in the device. The end of the strip is positioned such that each of the terminal contact pads overlay, are in contact with, or are in proximity to a heating surface. Such position within the tool will be referred to herein as the “soldering position.” “In proximity to,” as used herein, means within sufficient distance to enable effective soldering, for example being 0.1 to 3 mm.

The strip holder will comprise one or more strip anchoring elements. The strip anchoring element may comprise any structures or mechanisms that can be engaged to apply force to the strip such that it is secured in the device in soldering position, i.e., the strip does not slide out while the anchoring elements are engaged. The strip anchoring element may comprise a guide, for example, a channel, slot, track, parallel rails or other structures which can receive an LED strip of a selected size, for example, a rectangular groove which is matched to the width and height of the selected LED strip. The strip anchoring element may comprise one or more spring tensioned clips. Alternatively, the anchoring element may comprise one or more clamps, pins, or teeth, these structures being applied to the LED strip to hold it in place and being secured by spring tension, elastic tension, or a securing mechanism such as a latch or tension screw knob.

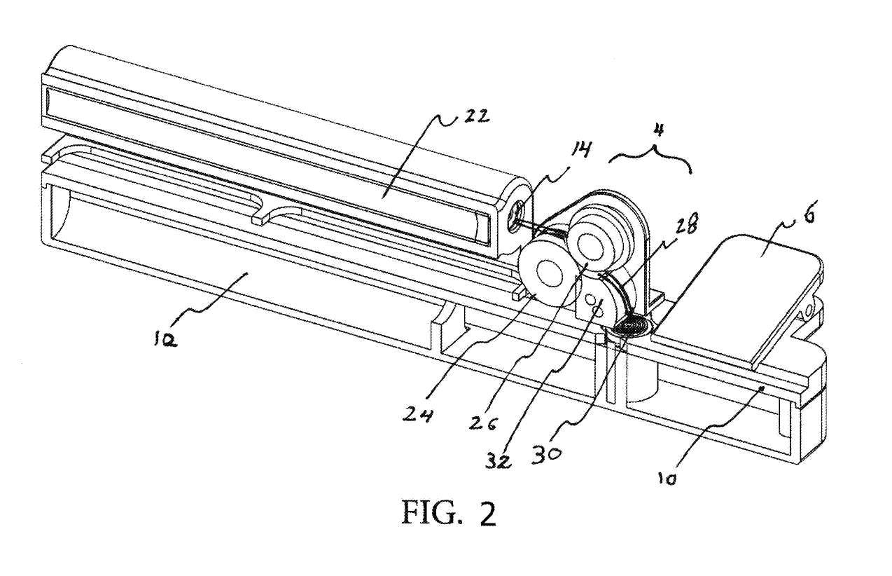

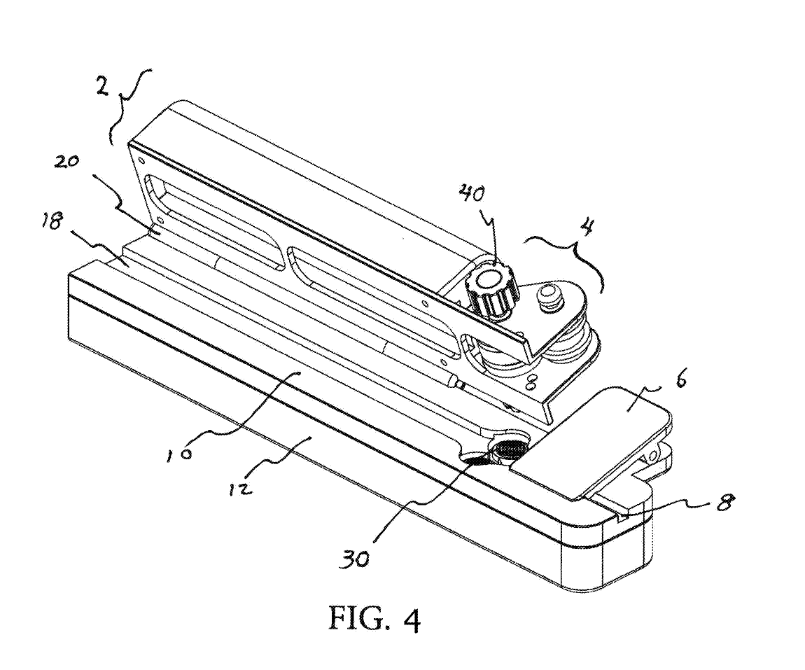

In one embodiment, the device comprises a hinged body and the strip anchoring element comprises opposing sections of the device body, for example as depicted in FIG. 2 and FIG. 4. In this implementation of the invention, the device comprises a hinged body having an open configuration and a closed configuration. In the open configuration (e.g., FIG. 4), the LED strip can be inserted into a track or groove (e.g. 18 in FIG. 4) and advanced such that the end of the strip is in the soldering position. In the closed configuration (e.g. FIG. 2), the opposing sections of the device are closed together, and the strip is sandwiched in between, securing it in soldering position.

Electrical Wire Holder. A second element of the device is an electrical wire holder. The function of the electrical wire holder is to position the ends of the electrical wires in soldering position, wherein the end of each wire is in contact with or in proximity to a contact pad at the terminal end of the LED strip. Typically, the LED strip will be connected to a power source by a multiple-wire cable, wherein two or more wires (e.g., a positive and negative wire) are twined together and/or encased in a common outer jacket or multi-channel insulating sheath. For connection to the LED tape, an end portion of cable is stripped of its jacket or sheath and the wires within are separated for connection to separate LED strip contact pads (with insulation, if any, stripped from each electrical wire end). Accordingly, the wire holder may be configured to position the wires by holding the cable in place. Alternatively, the electrical wire holder may be configured to separately secure each of the electrical wires in place.

The electrical wire holder will comprise one or more anchoring elements. The anchoring elements can be engaged or deployed to secure the cable and/or wires in place such that the ends of each wire are in soldering position. The anchoring element may comprise a cable guide. The cable guide aid may comprise a slot, groove, channel, or other structures sized and shaped to receive a multi-wire cable. The anchoring element may comprise one or more spring tensioned clips. The wire anchoring element may comprise one or more clamps, the clamps being applied to the wires to hold them in place and being secured by a mechanism such as a latch or tension screw knob.

Soldering Wire Feed Mechanism. The device will further comprise a solder wire feed mechanism. The solder wire feed mechanism comprises any combination of elements or devices that enables the controlled delivery of solder to each LED contact pad in the soldering position.

A first function of the solder wire feed mechanism is to position a solder wire at each terminal contact pad of the LED strip when it is in soldering position. The solder wire feed mechanism will comprise elements that enable the ends of each solder wire to be positioned in contact with or in proximity to a terminal contact pad of an LED strip.

A second function of the solder wire feed mechanism is to advance the solder wires during the soldering process. As the end of each solder wire is melted by the heating element, additional solder is fed into the growing bead of melted solder by advancing the wire into the soldering zone, until a melted solder bead of sufficient size to join the contact pad and wire is formed.

Solder wires are stored and advanced from a solder source. In one embodiment, the solder source comprises a standard solder wire tube in which spooled solder wire is contained. In another embodiment, the solder source comprises a spool of solder wire, which may be stored on an axle attached on or within the device housing.

The solder wire feed element will comprise structures that allow the user to advance the end of each solder wire towards an LED strip contact pad residing in the soldering position. In one embodiment, the feeding mechanism comprises one or more rollers. The rollers may comprise a ratcheting mechanism to prevent backwards movement of the solder wire. Alternatively, a friction plate or other structure may be engaged to keep the wires in place. The rollers may be motorized, for example, being engaged by an electrical motor under the control of a switch, button, trigger, or other control mechanism. The rollers may be powered by hand, for example, by use of a knob turned by the user.

In one embodiment, the solder feed mechanism comprises a sliding thumb plate. When depressed by the operator, teeth or like elements on the bottom of the plate can frictionally engage the one or more solder wires, and when the operator slides the plate forward (towards the contact pads in the soldering position), the solder wires are pulled and advanced.

The solder wire feed mechanism may be configured to advance the solder by a selected length, such length corresponding to the amount of solder wire needed to form a bead of sufficient size to join each contact pad and electrical wire. For example, 1-5 mm of solder may be used per joint. Such metered delivery of solder wire conveniently delivers the proper amount of solder to join the components. In one embodiment, the solder is metered by turning a knob for a set distance (quarter turn, half turn, etc.). In another embodiment, the solder is metered by the use of a sliding plate delivery system, wherein the length which the plate may slide is equal to the amount of solder required for the bead. In the case of motorized delivery of solder wire, the motor may be configured for metered delivery at an optimal speed for creating a solder bead, for example, in the range of 0.5 to 5 mm per second.

In an alternative embodiment, the solder feed mechanism comprises an assembly which delivers a pellet of solder into the soldering position, rather than wire.

Any type of solder may be used in the device of the invention, for example lead solder, lead-tin solder, lead-free solder, and solder comprising flux cores.

Soldering. When the LED strip contact pads, electrical wire ends, and solder wire ends are converged in soldering position, on or in proximity to the heating element surfaces, the user can activate the heating element to melt the solder and create a soldered connection. The heating element may be activated by a control such as a button, switch, or trigger. The heating element typically will need to reach temperatures between 600 to 800 degrees Fahrenheit to melt the solder. In one embodiment, upon the operator engaging the control, an electronic timer activates the heating element for a selected amount of time sufficient to perform a soldering operation, and then automatically shuts off the heating element.

The device may optionally comprise electronic sensing and control elements, such as temperature sensors and other electronics that sense when the heating element has reached soldering temperature. The device may be configured to alert the operator, for example by a tone or an indicator light, that soldering temperature has been reached.

In one embodiment, the system further comprises electronic controls and actuators that automatically advance the solder wires by a metered increment when soldering temperature is reached. The system may further comprise an automatic shut-off for the heating element(s) after the solder wires have been advanced.

The device may be configured such that the heating element surfaces are exposed, i.e. not encased or enclosed, such that the operator can visually determine that the wires, contacts, and solder are in position and when a bead of solder has been applied. Alternatively, the heating element(s) may be encased under a transparent window (e.g. glass), so that the operator can visually monitor the soldering process.

Detailed Description of the Preferred Embodiments. Next, a detailed description of certain exemplary embodiments is provided. It is to be understood, that the present invention may be embodied in various forms and that the exemplary embodiments provided herein are representative illustrations of the invention. It is to be understood that in some instances, various aspects of the invention may be depicted as exaggerated or enlarged in the figures to facilitate an understanding of the invention.

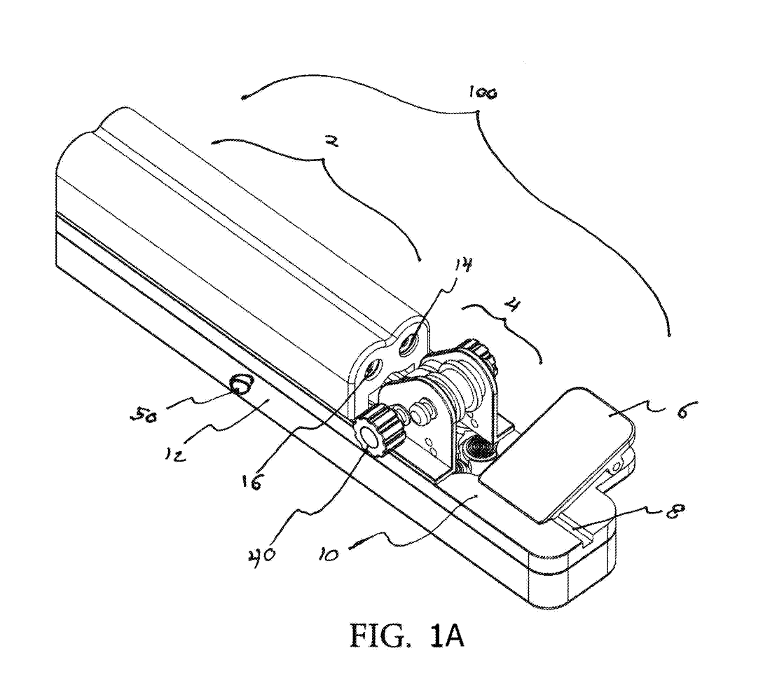

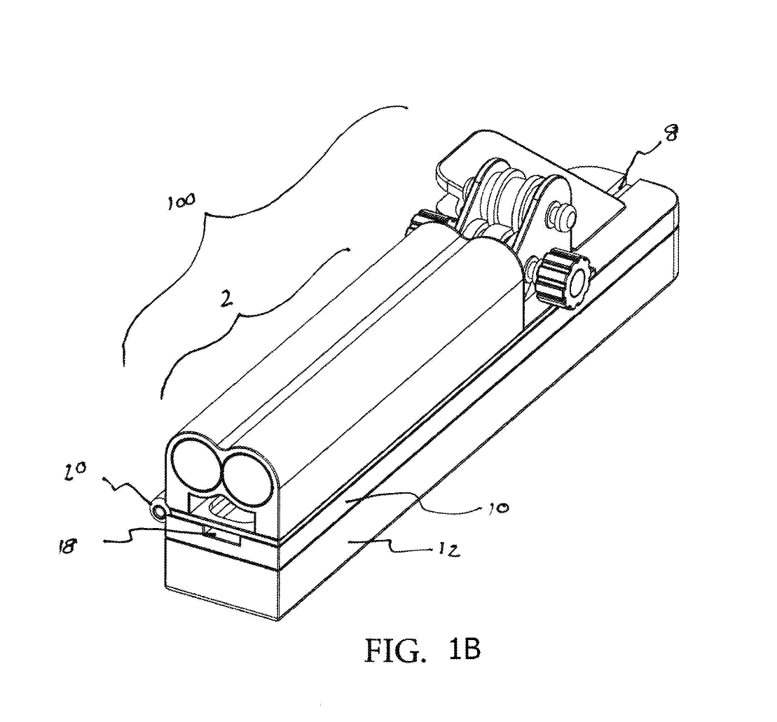

FIGS. 1-5 depict a first representative embodiment of the invention.

Referring to FIG. 1A, this diagram depicts a forward-looking perspective view of a device of the invention 100. In this embodiment, the power source of the heating element comprises a battery. A lower battery holding compartment 12 is covered by a flat lid 10. The flat lid 10 includes a cable guide comprising an indented track 8. The cable is removably retained by a wire holder anchoring element comprising a spring biased clip 6.

Track 18, shown in end view in FIG. 1B is sized to retain an LED strip of a selected size. Solder holding compartment 2 is sized to retain two standard tubes of coiled solder. Solder feed mechanism 4 is designed to pull the two lengths of solder out from the two tubes. The solder is drawn out by opposing rollers 24, 26 as shown in the section view in FIG. 2. which are turned when the user rotates knob 40.

The section view in FIG. 2 laterally bisects the device 100 and shows interior features. Standard solder tubes are stored in compartment 22. The free end of the solder 28 wire exits a front aperture 14 and is drawn out by rollers 24, 26 and then guided by quarter round piece 32. The ending location is directly above a heating element 30.

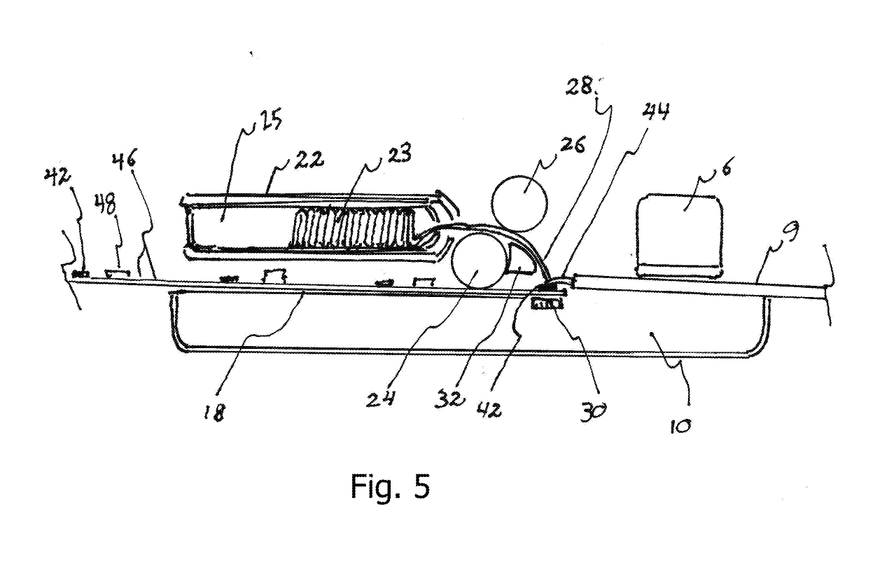

FIG. 5 shows a partial section view that includes the solder 23 coiled within tube 25 which is in turn retained by solder compartment housing 22. This view shows LED strip 46 which includes a plurality of LEDs 48 and a plurality of contact pads 42 for soldering wires onto the strip 48. The terminal end of the LED strip is inserted into the track 18 of the device so that each contact pad 42 is directly above a heating element 30. The wire tip 44 of cable 9 is positioned directly above heating element 30. The end of solder wire 28 lands on top of both the wire tip 28 and the contact pad 42. When the heater element is activated by an on/off switch 50, it melts solder 28 and the solder bead joins together the wire end 44 and the contact pad 42.

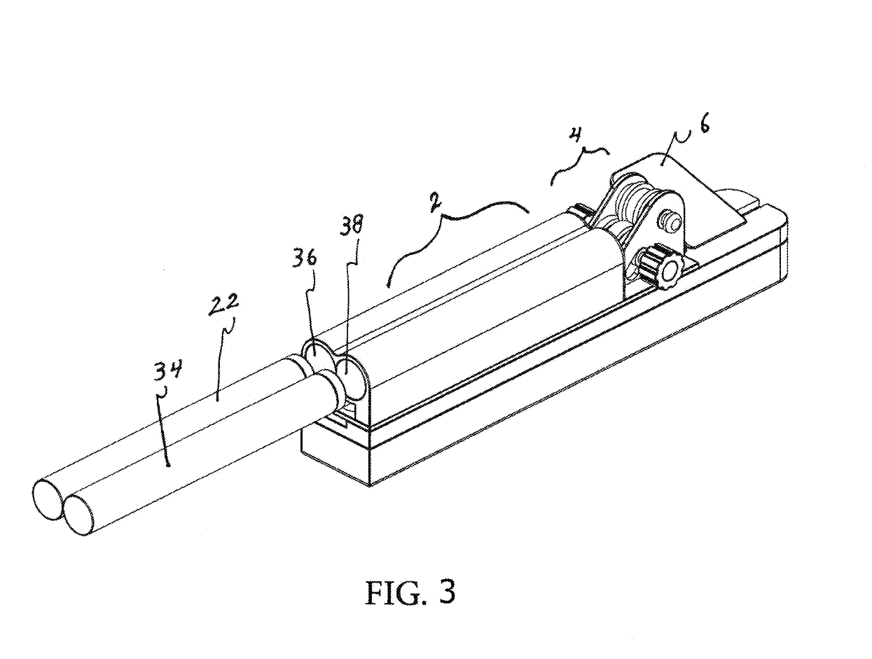

FIG. 3 is a rearward perspective view of the invention 100. In this view, solder tubes 22, 34 are shown ready to be inserted into apertures 36, 38 located at the rear of the solder tube compartment 2.

FIG. 4 is a perspective view showing a hinged 20 upper solder holding portion 2 lifted so that the operator can insert an LED strip into track 18. When the user closes the hinged solder holding portion 2, it acts to frictionally retain the LED strip in position so that it will not move during the soldering operation.

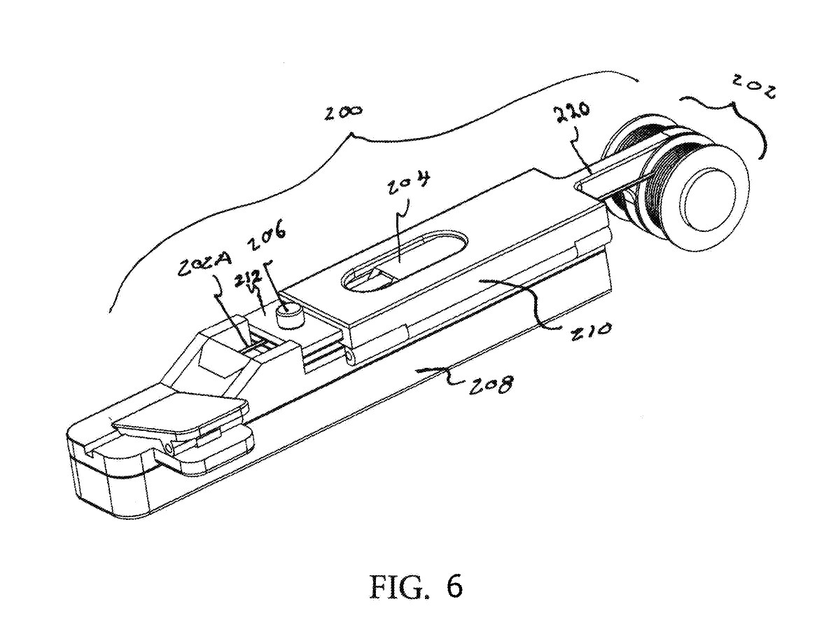

FIGS. 6-11 depict a second exemplary configuration of the device. The second embodiment 200 provides an alternate mechanism for storing and advancing twin solder lines in a reliable and accurate manner.

FIG. 6 is a perspective view of a second embodiment of the invention 200. A pair of solder reels 202 is supported by rigid spine or axle 220. The two lines of solder 202A extend through top hinged panel 210 and are directed to the landing pad as will be described below. Sliding advance panel 204 causes the solder 202A to advance incrementally as the user press down on and slides forward on panel 204. Threaded thumb screw 206 can be tightened onto plate 212 which can create a frictional force on solder wires 202A, so that when sliding advance panel 204 slides back to its start position, the solder 202A remains in its advanced position.

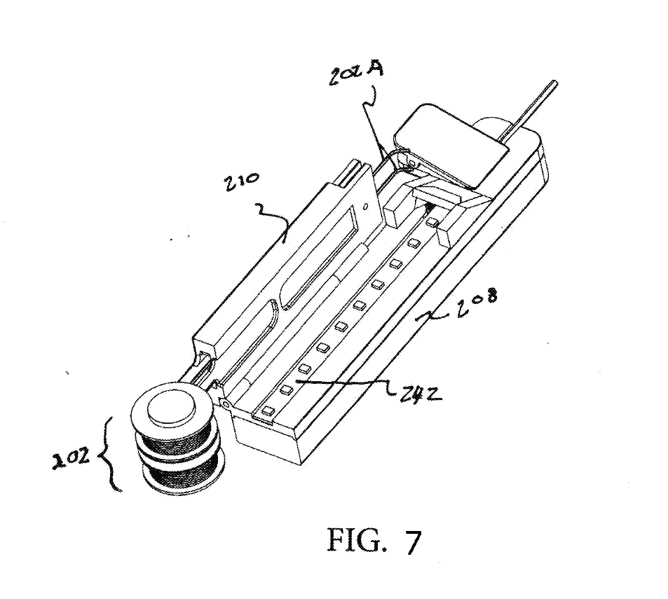

FIG. 7 is a perspective view of the second embodiment 200 with the top assembly 210 in the lifted or open position. The top assembly 210 holds the solder 202A in place within its tracks. LED strip 242 is visible in a strip guide comprising a groove.

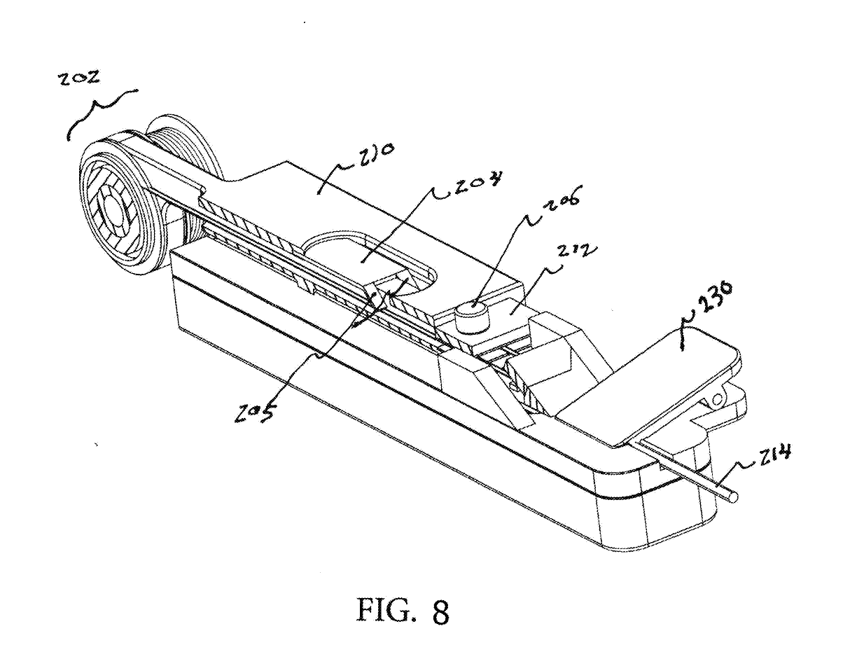

FIG. 8 is a section view of the second embodiment of the invention 200 that shows the workings of slide plate 204 which includes downward facing tabs 205 which can bite into the solder 202A when the user pushes down on plate 204 and then slides the plate and solder 202A forward incrementally. Friction plate 212 places a light friction force on the solder 202A so that it remains in its advanced position as the slide plate 204 returns to its start position. Cable 214 is shown in a wire guide comprising a groove, being held by a wire anchoring element comprising a spring clip 230.

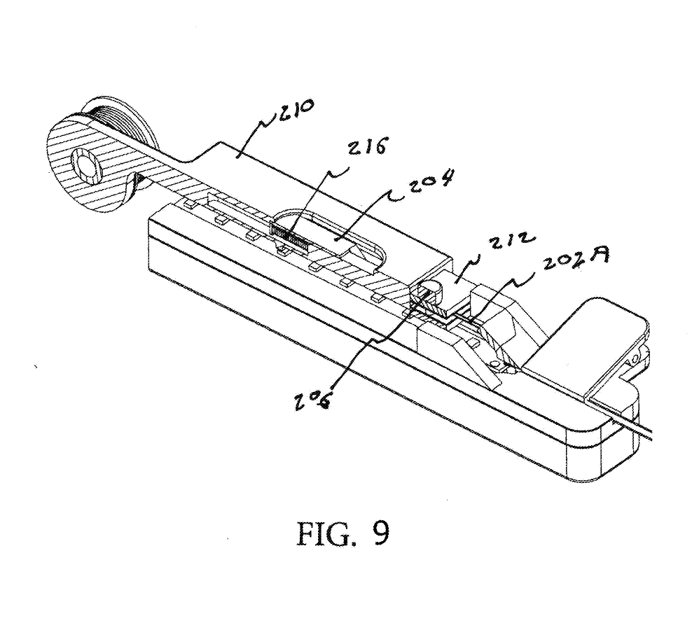

FIG. 9 is another section view of the second embodiment of the invention showing extension spring 216 which is attached to slide plate 204. The spring 216 pulls the slide plate 204 back to its original position after the user has advanced the solder wire 202A.

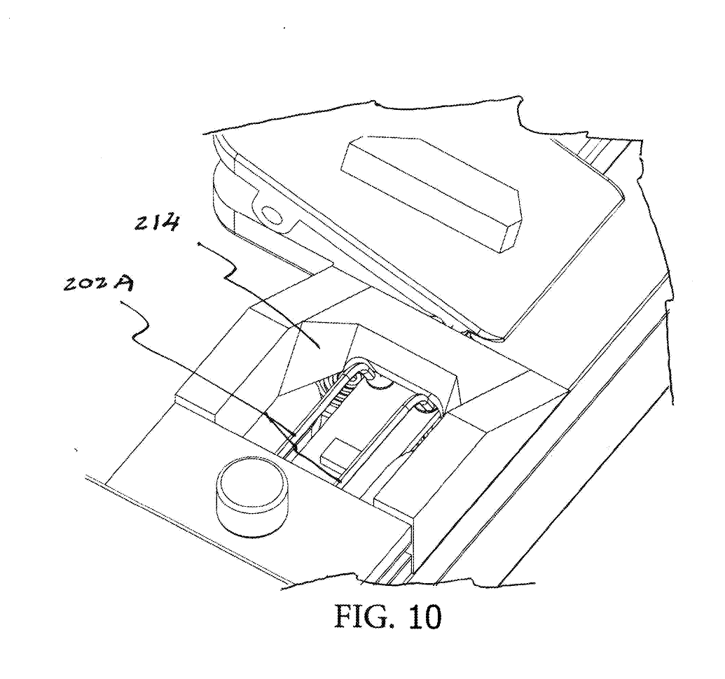

FIG. 10 is a partial perspective view of the second embodiment of the invention 200 showing a solder ends 202A positioned on the LED strip contacts.

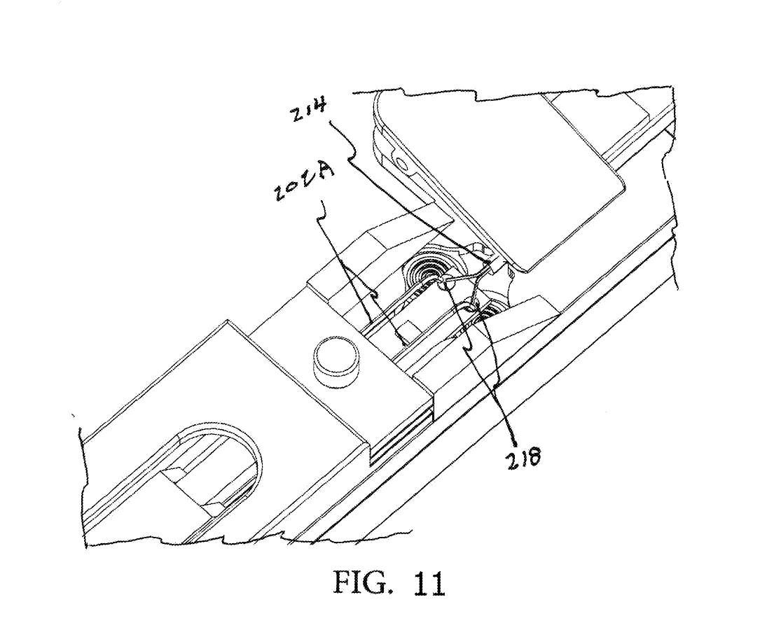

FIG. 11 is a partial perspective view that depicts the LED strip contacts 218, the two wires of a dual-wire cable 214, and solder wire 202A ends in position on the landing pads, ready for heating to create a solder connection between the strip contacts and wires.

Device Configurations. The device may be configured for a specific width of LED tape, e.g. 2, 5, or 8 mm widths. Alternatively, the device may be adjustable for use with LED strips of different widths. For example, in one embodiment, the LED strip holder comprises an adjustable LED strip guide comprising two parallel rails, wherein one or both rails may move laterally (i.e. perpendicularly with respect to the long axis of the LED strip) in order to conform to various LED strip widths. Likewise, the device may be configured with laterally moveable heating elements to optimally adjust their position under the terminal contact pads of the LED strip.

The device may comprise additional features, such as a lighting source for illumination of the soldering zone, handles to aid in holding the device, or attachment means for securing the device to a ladder or work surface.

Methods of the Invention. In addition to the devices described above, the scope of the invention encompasses methods of connecting LED tape to electrical wires. A basic method of the invention encompasses a method of using a device to joint electrical wires with terminal LED contact pads:
wherein the device comprises one or more heating elements sized and spaced to underlie, be in contact with, or be in proximity to each terminal contact pad of the LED strip, a heating element control, a heating element power source, an LED strip holder, an electrical wire holder, a solder wire feed mechanism, and a solder wire for each terminal LED strip contact pad;
wherein the method comprises the steps of:
securing the cut end of the LED strip, by the LED strip holder of the device, such that each terminal LED strip contact pad overlays, is in contact with, or is in proximity to one of the one or more heating elements;
positioning the ends of each of the electrical wires, by the electrical wire holder of the device, such that the end of each electrical wire is in contact with or is in proximity to one of the terminal LED strip contact pads;
positioning the end of each solder wire, by the solder wire feed mechanism of the device, such that each such solder wire end is is in contact with or is in proximity to one of the terminal LED strip contact pads;
activating the one or more heating elements by engaging the heating element control, such that the one or more heating elements reaches soldering temperature;
engaging the solder wire feed mechanism to feed a length of solder wire to each terminal LED strip contact pad to create a bead of melted solder sufficient to connect each wire end and LED strip contact pad;
turning off the one or more heating elements, allowing the melted solder to cool and solidify; and
releasing the LED strip holder and wire holder such that the now-connected LED strip and electrical wires are freed of the device.

The method may be applied using any of the device configurations described herein.

As described, the devices and methods described herein may be used to join LED strip to wires. Furthermore, it will be understood that the devices and methods of the invention are not limited to the use of LED strip, and may be adapted for joining any other electrical apparatus to wires, by adapting the LED strip holder portion of the device to the size and shape of the electrical apparatus.

All patents, patent applications, and publications cited in this specification are herein incorporated by reference to the same extent as if each independent patent application, or publication was specifically and individually indicated to be incorporated by reference. The disclosed embodiments are presented for purposes of illustration and not limitation. While the invention has been described with reference to the described embodiments thereof, it will be appreciated by those of skill in the art that modifications can be made to the structure and elements of the invention without departing from the spirit and scope of the invention as a whole.

What is claimed is:

1. A device for connecting each of the terminal contact pads present at the end of an LED strip to an electrical wire, comprising:
one or more heating elements;
an LED strip holder comprising one or more anchoring elements that can secure the end of the LED strip such that each terminal contact pad thereof overlays, is in contact with, or is in proximity to one of the one or more heating elements;
a wire holder comprising one or more anchoring elements that can secure electrical wires or a cable comprising multiple electrical wires, such that the end of each such electrical wire is in contact with or is in proximity to one of the terminal contact pads of the LED strip;
a solder wire feed mechanism, wherein the solder wire feed mechanism is configured to position one or more solder wires such that the end of each such solder wire is in contact with or is in proximity to one of the terminal contact pads of the LED strip, and wherein the solder wire feed mechanism, when engaged, will advance the end of each of the one or more solder wires towards a terminal contact pad of the LED strip;
a control element that enables an operator to activate and turn off the one or more heating elements; and
a heating element power source or power source connector.

2. The device of claim 1, wherein
the one or more heating elements comprises separate side-by-side heating elements spaced to underlie each of the the contact pads of the LED strip.

3. The device of claim 1, wherein
the LED strip holder comprises a groove sized for an LED strip or a spring tensioned clip, or wherein the LED strip holder comprises two sections of the device connected by a hinge, wherein the two sections can be closed to sandwich the LED strip in place.

4. The device of claim 1, wherein
the wire holder comprises a groove sized for a cable comprising multiple wires.

5. The device of claim 1, wherein
the wire holder comprises a spring-tensioned clip.

6. The device of claim 1, wherein
the solder wire feed mechanism comprises one or more rollers which can be rotated to advance the one or more solder wires.

7. The device of claim 6, wherein
the one or more rollers is motorized.

8. The device of claim 6, wherein
the one or more rollers is rotated by manually engaging a knob.

9. The device of claim 1, wherein
the solder wire feed mechanism comprises a sliding plate that, when depressed, can frictionally engage the one or more solder wires, and, when advanced, will advance each of the one or more solder wires.

10. The device of claim 1, wherein
the solder wire feed mechanism is configured to advance each solder wire at a metered length sufficient to form a bead for bonding an electrical wire end to an LED contact pad.

11. The device of claim 1, wherein
the device further comprises compartments wherein each compartment is sized to hold a solder wire tube.

12. The device of claim 1, wherein
the heating element power source is a battery integrated with the device, external battery pack, or power outlet.

13. The device of claim 1, wherein
the device comprises a temperature sensor and indicator means to alert the operator that the one or more heating elements has reached soldering temperature.

14. The device of claim 13, wherein
the solder feed mechanism is automated to advance each solder wire a metered length when the soldering temperature is reached.

15. The device of claim 14, further comprising
a control element which turns off the one or more heating elements after the metered length of soldering wire has been advanced.

16. The device of claim 1, wherein
the device is configured to connect two wires to an LED strip.

17. The device of claim 1, wherein
the device is configured to connect three wires to an LED strip.

18. The device of claim 1, wherein
the device is adjustable such that it can be configured to hold LED strip of different widths.

19. A method of connecting each of the terminal contact pads at the cut end of an LED strip to an electrical wire using a device,
wherein the device comprises one or more heating elements sized and spaced to underlie, be in contact with, or be in proximity to each terminal contact pad of the LED strip, a heating element control, a heating element power source, an LED strip holder, an electrical wire holder, a solder wire feed mechanism, and a solder wire for each terminal LED strip contact pad;
wherein the method comprises the steps of:
securing the cut end of the LED strip, by the LED strip holder of the device, such that each terminal LED strip contact pad overlays, is in contact with, or is in proximity to one of the one or more heating elements;
positioning the ends of each of the electrical wires, by the electrical wire holder of the device, such that the end of each electrical wire is in contact with or is in proximity to one of the terminal LED strip contact pads;
positioning the end of each solder wire, by the solder wire feed mechanism of the device, such that each such solder wire end is is in contact with or is in proximity to one of the terminal LED strip contact pads;
activating the one or more heating elements by engaging the heating element control, such that the one or more heating elements reaches soldering temperature;
engaging the solder wire feed mechanism to feed a length of solder wire to each terminal LED strip contact pad to create a bead of melted solder sufficient to connect each wire end and LED strip contact pad;
turning off the one or more heating elements, allowing the melted solder to cool and solidify; and
releasing the LED strip holder and wire holder such that the now-connected LED strip and electrical wires are freed of the device.
